(19) United States
(12) Patent Application Publication
(10) Pub. No.: US 2017/0071402 A1
(43) Pub. Date: Mar. 16, 2017

(54) DETACHABLE MICROWAVE BAKING PAN

(71) Applicant: Herman Peng, FoShan City (CN)

(72) Inventor: Herman Peng, FoShan City (CN)

(21) Appl. No.: 15/253,899

(22) Filed: Sep. 1, 2016

(30) Foreign Application Priority Data
Sep. 14, 2015 (CN) 2015207072481

(51) Int. Cl. A47J 36/02; B65D 81/34; A21B 3/13

(52) U.S. Cl. CPC A47J 36/027; A21B 3/132; B65D 81/3453

(57) ABSTRACT

An improved detachable microwave baking pan, comprising an upper baking pan and a lower baking pan which are disposed separately, wherein the upper baking pan is provided with an upper baking pan cavity, and the lower baking pan is provided with a lower baking pan cavity; lower grips are disposed on the edge of two sides of the lower baking pan, and each lower grip is provided with an elastic fastener in an integrated extension manner; upper grips are disposed on the edges of two sides of the upper baking pan, and each upper grip is provided with a fastening protrusion which is in corresponding fastening fit with the elastic fastener; the elastic fasteners are matched with the fastening protrusions, such that the upper baking pan and the lower baking pan are combined into a whole; and the upper baking pan cavity and the lower baking pan cavity are communicated to jointly constitute a heating cavity suitable for baking food. The upper baking pan and the lower baking pan are always elastically fastened by means of the elastic property of the elastic fasteners 203, and even if the food in the heating cavity is uneven in thickness, it is assured that both sides of the food can be baked, and the food is uniformly heated in the baking process.

### RELATED APPLICATION

The present application claims a priority benefit to China Patent Application No. 2015207072481 filed on Sep. 14, 2016, which is incorporated herein by reference.

### TECHNICAL FIELD

The present relates to the technical field of cooking utensils, and in particular to an improved detachable microwave baking pan.

### BACKGROUND ART

At present, for a majority of microwave baking pans in the market, food is heated and baked generally from the single side, and people need to turn over the food with hands, thus resulting in a poor baking effect and uneven heating to affect the mouthfeel of the food and waste time and electricity.

### SUMMARY

The present invention aims to solve the defects of the prior art, however, an objective of the present invention is to provide an improved detachable microwave baking pan.

The improved detachable microwave baking pan has the beneficial effects: the upper baking pan and the lower baking pan are always fastened by means of the elastic property of the elastic silica gel fasteners, and even if the food in the heating cavity is uneven in thickness, it is assured that both sides of the food can be baked, and the food is uniformly heated in the baking process.

### BRIEF DESCRIPTION OF DRAWINGS

FIG. 1 is a structural schematic drawing of the present invention.

FIG. 2 is an enlarged drawing of a portion A in FIG. 1 of the present invention.

FIG. 3 is a structural state drawing of the present invention.

FIG. 4 is a use state drawing of the present invention.

FIG. 5 is an exploded structural schematic drawing of the present invention.

FIG. 6 is a structural schematic drawing of the lower baking pan of the present invention.

FIG. 7 is a structural schematic drawing of the upper baking pan of the present invention.

FIG. 8 is a structural schematic drawing of the lower baking pan of the present invention.

FIG. 9 is a structural schematic drawing of the upper baking pan of the present invention.

### SPECIFIC EMBODIMENTS

The present invention is further illustrated below in conjunction with drawings and embodiments.

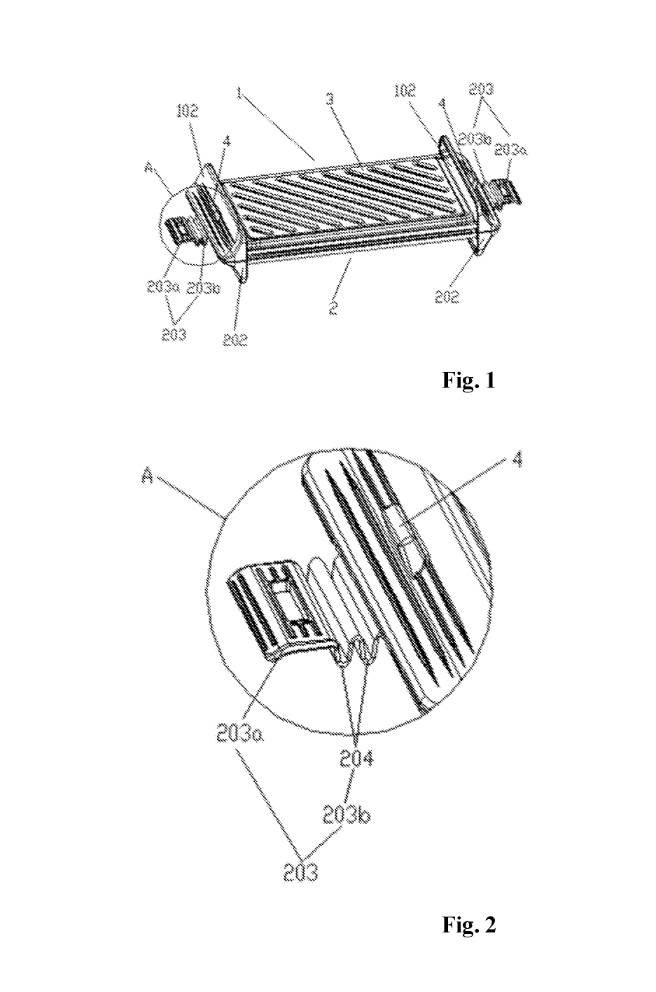

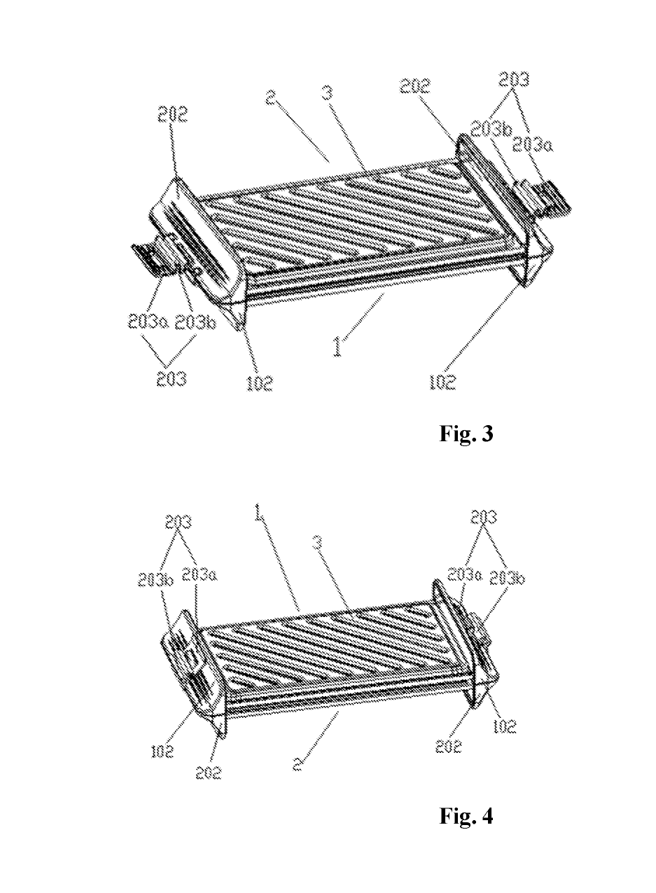

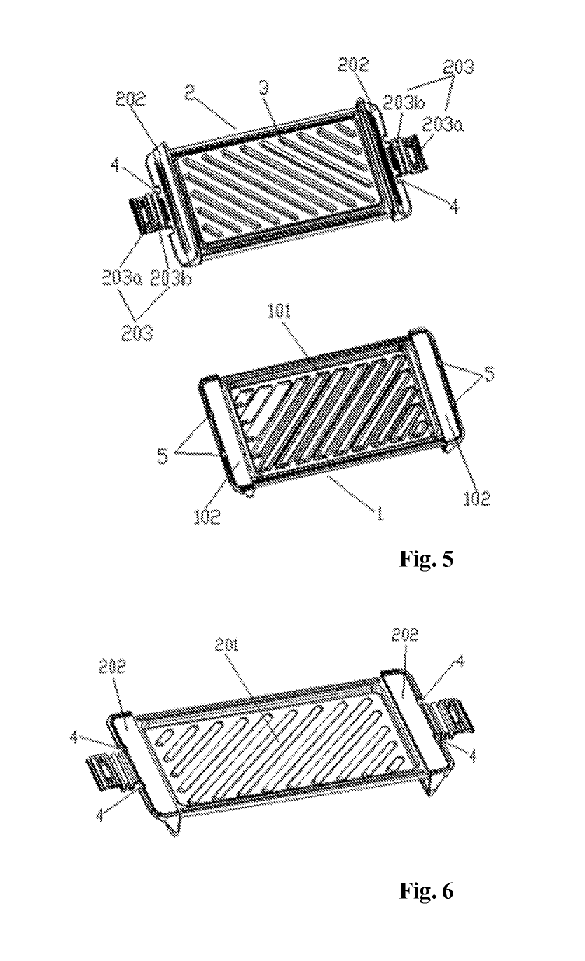

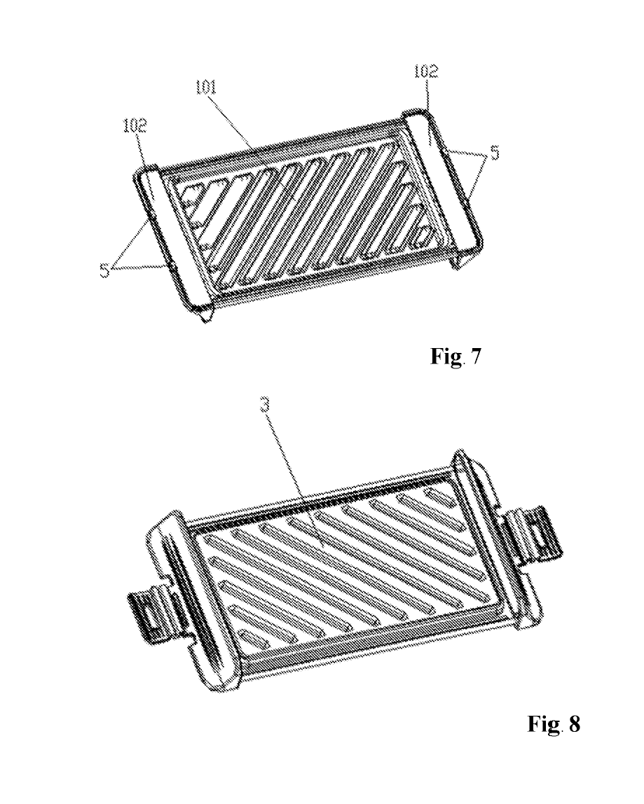

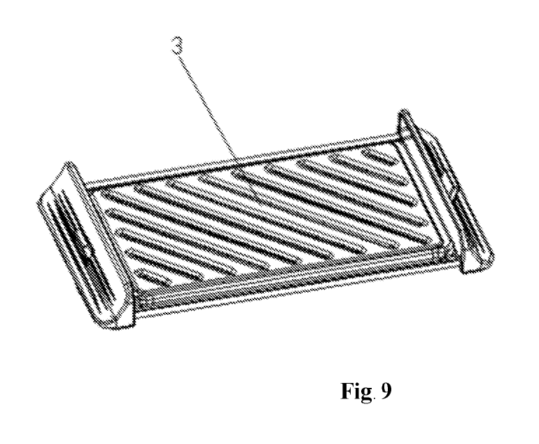

As shown in FIGS. 1-9, an improved detachable microwave baking pan comprises an upper baking pan 1 and a lower baking pan 2 which are disposed separately, wherein the upper baking pan 1 is provided with an upper baking pan cavity 101, and the lower baking pan 2 is provided with a lower baking pan cavity 201; lower grips 202 are disposed on the edges of two sides of the lower baking pan 2, and each lower grip 202 is provided with an elastic fastener 203 in an integrated extension manner; upper grips 102 are disposed on the edges of two sides of the upper baking pan 1, and each upper grip 102 is provided with a fastening protrusion 103 which is in corresponding fastening fit with the elastic fastener; the elastic fasteners 203 are matched with the fastening protrusions 103, such that the upper baking pan 1 and the lower baking pan 2 are combined into a whole; and the upper baking pan cavity 101 and the lower baking pan cavity 201 are communicated to jointly constitute a heating cavity suitable for baking food.

For the microwave baking pan adopting the structure, the upper baking pan 1 and the lower baking pan 2 are combined into a whole by fastening fit of the elastic fasteners and the fastening protrusions 103, such that the upper baking pan cavity 101 and the lower baking pan 201 are communicated to jointly constitute a heating cavity suitable for baking food, and therefore, the upper surface and the lower surface of the food may be baked simultaneously with good operability. The upper baking pan 1 and the lower baking pan 2 are always elastically fastened by means of the elastic property of the elastic fasteners 203, and even if the food in the heating cavity is uneven in thickness, it is assured that both sides of the food can be baked, and the food is uniformly heated in the baking process.

Each elastic fastener comprises a fastening plate 203a and an elastic expansion connector 203b.

For the microwave baking pan adopting the structure, the upper baking pan 1 and the lower baking pan 2 are combined into a whole by using fastening fit of the fastening plates 203a and the fastening protrusions 103; and further, by using the elastic property of the elastic expansion connectors 203b, the upper baking pan 1 and the lower baking pan 2 are closely clung to the food when the upper baking pan 1 and the lower baking pan 2 are used to bake thinner food or thicker food, such that it is assured that both sides of the food can be baked and uniformly heated.

Each elastic expansion connector 203b consists of a plurality of U-shaped elastic connectors 204.

For the microwave baking pan adopting the structure, each elastic expansion connector 203b consists of a plurality of U-shaped elastic connectors 204, such that the elastic expansion connectors 203b have an elastic compensation effect.

A microwave absorption and heating layer 3 is disposed on the outside surface of the upper baking pan 1 and the outside surface of the lower baking pan 2 respectively.

For the microwave baking pan adopting the structure, after the baking pan is put into a microwave oven, the absorption and heating layers are heated by microwaves, then the absorption and heating layers transfer heat to the upper baking pan 1 and the lower baking pan 2, and finally, the food is heated and baked by the lower baking pan 2 and the lower baking pan 1.

Two positioning recesses 4 are symmetrically disposed on both sides of each elastic fastener 203, and two positioning protrusions 5 which are in location fit with the two positioning recesses 4 are correspondingly disposed on both sides of the upper grip 102.

For the microwave baking pan adopting the structure, the two positioning recesses 4 and the two positioning protrusions 5 are in concave-convex fit, such that the upper baking pan 1 and the lower baking pan 2 are closed in a location manner to avoid displacement.

The microwave absorption and heating layer comprises a mix of the components in percentage by weight:

10% to 90% of wave absorber and 10% to 90% of auxiliary material.

The wave absorber is a mix of one or more than two of ferrite powder, or carbonyl iron powder, or graphite powder, or carbon fiber, or conductive carbon black, or acetylene carbon black or silicon carbide, and the auxiliary material is synthetic rubber or a binding material.

The synthetic rubber refers to high-temperature resistant rubber, or silicone rubber or fluororubber specifically. The above-mentioned specific embodiments are just better embodiments of the present invention, and all the equivalent designs made according to the application patent scope of the present invention should be covered by the technology of the present invention.

1. An improved detachable microwave baking pan, comprising an upper baking pan and a lower baking pan which are disposed separately, wherein the upper baking pan is provided with an upper baking pan cavity, and the lower baking pan is provided with a lower baking pan cavity; lower grips are disposed on the edge of two sides of the lower baking pan, and each lower grip is provided with an elastic fastener in an integrated extension manner; upper grips are disposed on the edges of two sides of the upper baking pan, and each upper grip is provided with a fastening protrusion which is in corresponding fastening fit with the elastic fastener; the elastic fasteners are matched with the fastening protrusions, such that the upper baking pan and the lower baking pan are combined into a whole; and the upper baking pan cavity and the lower baking pan cavity are communicated to jointly constitute a heating cavity suitable for baking food.

2. The improved detachable microwave baking pan of claim 1, wherein each elastic fastener comprises a fastening plate and an elastic expansion connector.

3. The improved detachable microwave baking pan of claim 1, wherein each elastic expansion connector consists of a plurality of U-shaped elastic connectors.

4. The improved detachable microwave baking pan of claim 1, wherein a microwave absorption and heating layer is disposed on the outside surface of the upper baking pan and the outside surface of the lower baking pan respectively.

5. The improved detachable microwave baking pan of claim 1, wherein two positioning recesses are symmetrically disposed on both sides of each elastic fastener, and two positioning protrusions which are in location fit with the two positioning recesses are correspondingly disposed on both sides of each upper grip.

6. The improved detachable microwave baking pan of claim 4, wherein the microwave absorption and heating layer comprises a mix of the components in percentage by weight:
10% to 90% of wave absorber and 10% to 90% of auxiliary material.

7. The improved detachable microwave baking pan of claim 6, wherein the wave absorber is a mix of one or more than two of ferrite powder, or carbonyl iron powder, or graphite powder, or carbon fiber, or conductive carbon black, or acetylene carbon black or silicon carbide, and the auxiliary material is synthetic rubber or a binding material.
